(19) United States
(12) Patent Application Publication
(10) Pub. No.: US 2026/0370544 A1
(43) Pub. Date: Nov. 19, 2026

(54) SYSTEMS AND METHODS FOR CHATBOT-DRIVEN NETWORK MANAGEMENT

(71) Applicant: PLUME DESIGN, INC., Palo Alto, CA (US)

(72) Inventors: Adam HOTCHKISS, Dallas, TX (US); Chris MANOLARAKIS, Sacramento, CA (US); Sridhar NATHAN, Santa Ana, CA (US); Yusuke SAKAMOTO, Campbell, CA (US)

(21) Appl. No.: 19/212,016

(22) Filed: May 19, 2025

(51) Int. Cl. H04L 41/0681; H04L 41/16; H04L 43/04; H04L 51/02

(52) U.S. Cl. CPC H04L 41/0681; H04L 41/16; H04L 43/04; H04L 51/02

(57) ABSTRACT

Disclosed are computerized systems and methods for a DI-based computerized framework for a scalable, AI/ML-executed application for network management, control and/or curation based on real-time network traffic and activity. The disclosed framework is configured for real-time network troubleshooting powered by AI/ML. The framework can provide an intelligent system capable of diagnosing and resolving network issues through multiple engagement channels. In some implementations, the framework can implement a multi-agent architecture that enables interaction with users via a conversational interface, delivering personalized guidance and automated network interventions. In some embodiments, the framework can operate in modes including: as a self-service application accessible directly to subscribers, as a web-based companion tool for customer support representatives, and as a system-level integration that augments existing operational infrastructure. The framework can employ advanced language model technologies to perceive network conditions, apply complex reasoning to identify root causes, and develop and/or execute action plans for issue resolution.

### FIELD OF THE DISCLOSURE

The present disclosure relates to network management, and more particularly, to a decision intelligence (DI)-based computerized framework for a scalable, artificial intelligence/machine learning (AI/ML)-executed application for network management, control and/or curation based on real-time network traffic and activity.

### SUMMARY OF THE DISCLOSURE

According to some embodiments, the disclosed systems and methods provide a computerized framework can be developed to enable real-time troubleshooting of a network through an intelligent interface that leverages AI/ML models (e.g., large language models (LLMs)) to interact with users and guide, manage and/or control how the user's network and/or connected or providing devices operate. Accordingly, in some embodiments, as discussed herein, the disclosed framework can operate to provide real-time functionality/capabilities for a user and/or devices connected to a network to troubleshoot networking and/or device issues detected or occurring on a network; and in some embodiments, such issues subject to computational troubleshooting in real-time (e.g., as they occur), according to a schedule, upon requests (e.g., from devices and/or users), according to a criteria (e.g., event detection, event time, a time, date, update, software patch, installation, power or network outage, and the like), and the like, or some combination thereof.

As discussed herein, the disclosed framework can be designed to operate at various levels of implementation, including local deployment on user devices and server-side integration for remote assistance scenarios. The framework can utilize AI/ML techniques to analyze network parameters, identify issues, and generate actionable recommendations for resolving network instabilities, defects, and faults. As discussed below, such compiled and/or caused resolutions can be performed autonomously and/or semi-autonomously upon user approval. In some embodiments, the framework can integrate with existing network infrastructure to collect real-time data about network performance, device connectivity, and traffic patterns, in addition to accessing a collection of data about subscribing users (e.g., historical and/or behavior data for network locations, users, devices, applications, and the like (for example, past interactions with customer support, and the like)) to inform its analysis.

In some embodiments, as discussed herein, the framework can employ natural language processing (NLP) capabilities to enable users to describe network issues using “everyday” (or natural) language, without requiring technical expertise or specialized terminology. The framework can interpret these descriptions, correlate them with observed network metrics, and formulate appropriate diagnostic strategies. In some embodiments, the framework can maintain a comprehensive knowledge base of common network issues, their symptoms, potential causes, and effective remediation approaches. This knowledge base can be continuously updated based on new troubleshooting scenarios, emerging network technologies, and evolving best practices in network management.

In some embodiments, the framework can operate in multiple modes of user interaction. In some embodiments, in a local implementation mode, the framework can be deployed as an agent, bot, application, plug-in to another application, web-based service accessible directly from the user's device, and the like (e.g., software installed on a user's device, accessible over the internet, or some combination thereof). The framework can function to provide interactive capabilities with a user, for example, via messaging, voice, video, audio, and the like, such that a multi-media experience can be realized so that troubleshooting capabilities can be provided and/or executed (e.g., the framework can function as a messaging interface and/or plug-in to a third party messaging interface (e.g., WhatsApp®, for example), where messages can be exchanged pursuant to the compilation and/or execution of troubleshooting instructions, as discussed herein). As discussed herein, through this local access point, users can engage with the framework's LLM-powered chatbot interface to report experienced and/or observed network issues or to request assistance with network optimization. The framework can respond to these requests by initiating diagnostic procedures, collecting relevant network data, and analyzing the results to determine the root cause of any detected problems.

In some embodiments, as discussed below, the framework can leverage AI/ML algorithms to analyze patterns in network behavior, enabling the framework to detect anomalies that might indicate impending issues before they manifest as noticeable performance degradation. Such predictive capability can allow the framework to recommend preventative measures, potentially averting network failures before they impact users. The framework can also learn from historical troubleshooting sessions, improving its diagnostic accuracy and recommendation relevance over time through reinforcement learning techniques.

In some embodiments, the framework can provide multifaceted recommendations based on its analysis. Such recommendations can range from simple user actions, such as restarting a device or relocating a wireless access point, to more complex automated network configuration changes. In some embodiments, the framework can generate step-by-step instructions tailored to the user's technical proficiency level, ensuring that recommendations remain accessible and actionable regardless of the user's networking expertise. The framework can accompany these instructions with explanations of the underlying issues and the expected outcomes of the recommended actions, educating users while solving their immediate problems.

In some embodiments, beyond providing recommendations, the framework can be configured to take direct action on the network when appropriate. In some embodiments, the framework can execute operations automatically to address identified issues without requiring user intervention (e.g., customer and/or customer support agent intervention). These operations can include, but are not limited to, adjusting quality of service settings, modifying routing tables, updating firmware on network devices, reconfiguring access points, resetting problematic connections, and the like, or some combination thereof. The framework can implement safeguards around these automatic interventions, such as verifying that proposed changes will not disrupt critical network services and creating backups of existing configurations before making modifications.

In some embodiments, the framework can maintain a comprehensive audit trail of all diagnostic activities, recommendations provided, actions taken, and the like (which, in some embodiments, can also include, but not be limited to, previous activities, previous solutions, service activities/charges, subscription information, and the like). Such logging capability can serve multiple purposes, including enabling review of troubleshooting effectiveness, providing documentation for compliance requirements, and supporting continuous improvement of the framework's algorithms and knowledge base. Such logging can be secured in storage, which can be located in association with, but not limited to, a cloud service, third party provider, service provider, local user device, and the like, or some combination thereof. In some embodiments, the framework can anonymize and aggregate these troubleshooting records to identify common patterns of network failure and successful resolution strategies, contributing to broader network management knowledge. Accordingly, as discussed below, such logging can be utilized to determine a context for a troubleshooting event and/or user associated with such event, such that the generated troubleshooting actions can be personalized or curated to such context to provide an improved user experience, as well as a more expeditious, resource-friendly and/or accurate mitigating response.

In some embodiments, for remote assistance scenarios, the framework can be accessed at a server level, enabling, for example, call center representatives to leverage its capabilities when assisting users. Thus, for example, in some embodiments, as discussed herein, when a user contacts a support center via call, text, message, and/or chat, support personnel can activate the framework to perform remote diagnostics on the user's network. The framework can collect data from the user's network environment, analyze it using the same algorithms employed in local mode, and present findings and recommendations to the support representative. This approach can enhance the effectiveness of human support staff by providing them with AI/ML-augmented insights and troubleshooting capabilities.

In some embodiments, the framework can establish secure connections to the user's network infrastructure when operating in remote mode, allowing it to gather detailed diagnostic information while maintaining appropriate security protocols. In some embodiments, the framework can implement various authentication mechanisms to ensure that only authorized support representatives can initiate remote troubleshooting sessions and that these sessions are limited to the specific network components relevant to the reported issue. The framework can also incorporate privacy-preserving techniques to minimize the collection or processing of sensitive data during remote diagnostics.

In some embodiments, the framework can enable support representatives to execute recommended actions remotely through its interface. These actions can range from simple configuration changes to comprehensive network resets, depending on the nature and severity of the identified issues. In some embodiments, the framework can provide a simulation capability that allows support representatives to preview the expected outcomes of proposed actions before implementing them, reducing the risk of unintended consequences during remote interventions.

In some embodiments, the framework can adapt its approach based on the specific network environment it encounters. It can recognize various network architectures, including traditional client-server models, mesh networks, software-defined networks, and hybrid configurations incorporating multiple connectivity technologies. In some embodiments, the framework can tailor its diagnostic procedures and recommendations to account for the unique characteristics and constraints of each network type, ensuring relevance and effectiveness across diverse deployment scenarios.

In some embodiments, the framework can integrate with a wide range of network devices through standard protocols and proprietary interfaces. In some embodiments, the framework can communicate with routers, switches, access points, gateways, and connected client devices, and the like, to collect diagnostic data and implement corrective actions. In some embodiments, the framework can maintain an extensible device compatibility layer that can be updated to support new devices and protocols as they emerge in the market, ensuring ongoing relevance in evolving network environments.

In some embodiments, the framework can implement prioritization mechanisms for addressing multiple concurrent issues. That is, for example, when analyzing a network with several problems, the framework can identify dependencies between issues and establish an optimal sequence for resolution. In some embodiments, the framework can consider factors such as, but not limited to, the impact of each issue on network performance, the complexity of potential solutions, and the prerequisite relationships between different remediation steps when determining this sequence.

In some embodiments, the framework can incorporate feedback mechanisms that allow users and support representatives to rate the effectiveness of provided recommendations and automatic actions. This feedback can be used to refine the framework's decision-making algorithms and to adjust the weighting of different solution approaches in its recommendation engine. In some embodiments, the framework can implement A/B testing of alternative troubleshooting strategies for similar issues, enabling data-driven optimization of its resolution pathways over time.

In some embodiments, the framework can operate with varying levels of autonomy, which in some embodiments, may be based on user preferences, and/or internet provider and/or organizational policies. In some embodiment deployments, the framework can be configured to require explicit approval before executing any network changes, while in others it may be authorized to take immediate action for certain categories of issues. In some embodiments, the framework can implement a tiered autonomy model where routine, low-risk interventions proceed automatically while more significant changes trigger notification and approval workflows.

Moreover, in some embodiments, in addition to using the AI/ML techniques discussed herein, engine 200 can utilize lightweight heuristic approaches, which can be utilized to reduce resource consumption (e.g., when needed or required) and/or when rapid deployment is necessary. Indeed, in some embodiments, hybrid approaches combining such methods with minimal AI/ML components can strike an effective balance between computational efficiency and troubleshooting effectiveness and/or quality. Accordingly, any type or version of known or to be known heuristic mechanisms can provide advantages in terms of interpretability, customization, processing speed, and resource efficiency, making them particularly suitable for edge devices or environments with connectivity limitations.

In some embodiments, the framework can provide real-time visibility into network health through intuitive visualizations and status indicators. These representations can help users and support personnel quickly grasp the current state of the network, identify problem areas, and monitor the effects of implemented solutions. In some embodiments, the framework can generate dynamic network topology maps that highlight connectivity issues, bandwidth constraints, and device health metrics, providing context for its diagnostic findings and recommendations.

In some embodiments, the framework can incorporate explainable AI principles to ensure that its analyses and recommendations remain transparent and understandable. For example, according to some embodiments, the framework can provide information that articulates (message or display) the reasoning behind its conclusions, citing specific network observations, established troubleshooting principles, and historical precedents that inform its approach. In some embodiments, the framework can provide multiple levels of explanation detail, allowing users to probe more deeply into the technical underpinnings of its recommendations if desired. Indeed, such information can involve generated summaries of multi-dimensional key performance indicators (KPIs) that enables users, service providers, and the like to understand the impact of the AI analysis and/or output action(s), and the like.

The framework can implement security measures to protect both the framework, devices on the network and/or the networks being managed. For example, such measures can include, but are not limited to, encrypted communications, secure authentication for all interaction channels, protection against injection attacks in its conversational interface, censoring or obfuscation of outputs of the conversational interface, isolation mechanisms to prevent exploitation of its network control capabilities, and the like. In some embodiments, the framework can conduct regular security self-assessments and can alert administrators to potential vulnerabilities in either its own implementation or in the networks it monitors.

In some embodiments, the framework can be designed with scalability in mind, capable of operating effectively across networks of varying sizes and complexities. In some embodiments, the framework can adjust its resource utilization based on the scale of the network being managed, from small home networks with a handful of devices to enterprise environments with thousands of connected endpoints. In some embodiments, the framework can implement distributed processing architectures for large-scale deployments, distributing analytical workloads across multiple nodes while maintaining a unified interface and coherent troubleshooting approach.

In some embodiments, the framework can support customization to address industry-specific networking requirements and compliance considerations. For example, such customizations can include and/or account for, but not be limited to, troubleshooting workflows, support logs, and the like, from third parties, access, core and/or transport networks, service providers, and the like, or some combination thereof. It can be configured with specialized knowledge bases for healthcare, finance, education, manufacturing, and other sectors with unique networking needs. In some embodiments, the framework can incorporate awareness of relevant regulatory frameworks such as, but not limited to, California Consumer Privacy Act (CCPA), GDPR (General Data Protection Regulation), and the like, ensuring that its troubleshooting approaches and data handling practices align with applicable compliance requirements.

In some embodiments, the framework can provide comprehensive reporting capabilities to document network status, identified issues, implemented solutions, and resulting performance improvements. In some embodiments, such reports can be generated automatically at regular intervals or on-demand following troubleshooting activities. In some embodiments, the framework can produce different report formats tailored to various stakeholders, from technical summaries for information technology (IT) personnel to executive overviews for management and simplified explanations for end users. In some embodiments, such reports can be appended, included and/or incorporated into third party systems leveraged by support agents for record keeping and/or future reference, as discussed below.

In some embodiments, the framework can integrate with existing IT service management systems through standardized application program interfaces (APIs), enabling seamless incorporation into established support workflows. It can automatically generate and update trouble tickets, associate diagnostic findings with specific incidents, and document resolution steps within the organization's system of record. In some embodiments, the framework can synchronize its knowledge base with the organization's configuration management database, ensuring that its recommendations remain aligned with approved software versions, hardware configurations, and network architectures.

In some embodiments, the framework can support collaborative troubleshooting scenarios involving multiple participants. In some embodiments, the framework can facilitate shared diagnostic sessions where several support representatives can simultaneously view network data, exchange observations, and collaboratively develop resolution strategies. In some embodiments, the framework can maintain a persistent context across multiple support interactions related to the same issue, ensuring continuity when troubleshooting efforts span shifts or require escalation to specialized teams.

In some embodiments, the framework can implement appropriate telemetry and monitoring capabilities to track its own performance and resource utilization. Such metrics can help administrators ensure that the framework operates efficiently and effectively, identifying potential bottlenecks or capacity issues before they impact troubleshooting capabilities. Such metrics, for example, can also further be utilized for informing other users and/or applications (e.g., administrators) of network providers, such that network events (e.g., bottlenecks, low throughput, and the like) can be mitigated and/or predicted and prevented. In some embodiments, the framework can include self-optimization mechanisms that adjust its resource allocation and processing strategies based on observed usage patterns and performance data.

In some embodiments, the framework can be configured to execute both reactive and proactive operational modes of operation. In reactive mode, the framework can respond to user-reported issues and/or detected network anomalies by initiating targeted diagnostic procedures. In proactive mode, the framework can monitor network health indicators and performance metrics, identifying potential issues before they escalate into user-impacting problems. In some embodiments, the framework can balance these modes dynamically, allocating more resources to proactive monitoring during periods of low reactive demand and shifting focus to address urgent issues when they arise.

In some embodiments, the framework can incorporate knowledge from multiple sources to enhance its troubleshooting capabilities. These sources can include manufacturer documentation for network devices, industry best practices, crowdsourced resolution strategies, and academic research on network optimization. In some embodiments, the framework can implement a flexible ontology for organizing this knowledge, allowing it to identify relevant information across domains and apply lessons from one network context to similar situations in different environments.

In some embodiments, the framework can leverage natural language generation techniques to produce clear, contextually appropriate communications throughout the troubleshooting process. These communications can be tailored to the recipient's role, technical expertise, and relationship to the network issue. In some embodiments, the framework can adjust its terminology, explanation depth, and recommendation specificity based on whether it is communicating with network administrators, support personnel, or end users experiencing network problems.

In some embodiments, the framework can implement continuous learning mechanisms to refine its capabilities over time. In some embodiments, the framework can analyze the outcomes of previous troubleshooting activities, identifying successful and unsuccessful approaches to specific network issues. In some embodiments, the framework can incorporate federated learning techniques that allow it to benefit from experiences across multiple deployments while preserving the privacy and separation of individual network environments. In some embodiments, the framework can utilize human-in-loop (HIL) mechanisms to evaluate performance and systematically modify, curate and/or adjust parameters for optimized results.

In some embodiments, the framework can provide comprehensive documentation of its own functionality, architecture, and interfaces to facilitate integration with existing systems and processes. This documentation can include, but is not limited to, detailed API specifications, deployment guidelines, configuration options, and customization approaches. In some embodiments, the framework can generate dynamic documentation that reflects its current configuration and capabilities, ensuring that technical resources remain synchronized with the actual implementation as it evolves over time.

According to some embodiments, a method is disclosed for a DI-based computerized framework for a scalable, AI/ML-executed application for network management, control and/or curation based on network traffic and activity. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for a DI-based computerized framework for a scalable, AI/ML-executed application for network management, control and/or curation based on network traffic and activity.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub -networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. According to some embodiments, as discussed herein, disclosed is a computerized framework that provides real-time troubleshooting capabilities for network environments. The framework can operate as a first responder for addressing various network issues, offering immediate assistance to users experiencing connectivity problems, application performance degradation, or device-related challenges. In some embodiments, the framework can be implemented as a conversational agent accessible through multiple interaction channels, including text-based chat interfaces and voice-based communication, enabling natural language engagement between users and the troubleshooting system.

In some embodiments, the framework can function in two primary operational modes to accommodate different user preferences and support scenarios. In the first mode, the framework can be deployed as a consumer-facing application that users can access directly on their devices when experiencing network issues. This local implementation can leverage the framework's intelligence to diagnose and resolve problems without requiring external human intervention. In the second mode, the framework can be implemented as a web-based interface for call center representatives, providing enhanced troubleshooting capabilities when users opt to contact customer support directly. This dual-mode approach can ensure comprehensive support coverage regardless of user preferences for self-service or assisted troubleshooting.

In some embodiments, the framework can differentiate itself through the comprehensive assimilation of data from multiple sources. In some embodiments, the framework can gather information from both consumer-side network elements (devices, local routers, access points) and operator-side infrastructure (servers, backbone networks, access networks, fiber connections). Such data collection mechanisms can provide unprecedented visibility into the complete connectivity path, allowing the framework to identify issues that might be invisible when examining only one segment of the network. In some embodiments, the framework can employ specialized data collection mechanisms, sometimes characterized as “bots”, that can be rapidly deployed to gather relevant information across network touchpoints when troubleshooting sessions are initiated.

In some embodiments, the framework can correlate the assimilated data to perform accurate and rapid root cause analysis when users report problems. As discussed herein, such reasoning component can distinguish between multiple potential causes and identify the most likely explanation for observed symptoms, significantly improving the precision of troubleshooting efforts. In some embodiments, the framework can be optimized to deliver quick, accurate diagnoses that enable first-call resolution of issues, thereby enhancing overall customer satisfaction and loyalty metrics for service providers.

In some embodiments, the framework can provide actionable recommendations based on its diagnostic conclusions and can potentially implement solutions directly. In some embodiments, the framework can determine appropriate responses to identified issues and either guide users through manual resolution steps or automatically execute necessary changes to restore normal network operation. In some embodiments, the framework can distinguish between problems that require human intervention (such as relocating physical equipment or removing obstructions) and those that can be addressed through automated network configuration adjustments (such as channel changes or signal optimizations). This flexibility in response execution can maximize resolution efficiency while accommodating scenarios that necessarily involve physical manipulation of devices.

In some embodiments, the framework can deliver significant value to network operators by enabling more efficient support operations and improved customer experiences. In some embodiments, the framework can reduce average handle times for support calls, increase first-contact resolution rates, and improve net promoter scores through more effective problem resolution. The framework can leverage the unique position of service providers who possess extensive knowledge about their network infrastructure and aggregated insights from supporting numerous similar deployments. This knowledge advantage can enable the framework to outperform generic troubleshooting approaches that lack access to comprehensive network data and historical performance patterns.

In some embodiments, the framework can implement a decision tree approach when evaluating potential actions to take in response to identified issues. In some embodiments, the framework can rapidly converge on optimal resolution strategies through structured evaluation of available options, considering factors such as likelihood of success, implementation complexity, potential side effects, and user impact. The framework can employ AI/ML algorithms for action selection while adapting them to the specific requirements of network troubleshooting scenarios, ensuring that interventions address root causes without introducing new problems or degrading performance in other areas.

In some embodiments, the framework can operate (continuously, periodically and/or via an event-based criteria (e.g., time, event detection, and the like), or some combination thereof) in the background, monitoring network performance even when not actively engaged in troubleshooting sessions. In some embodiments, the framework can establish baseline performance expectations for individual network environments and detect anomalies or degradations that might indicate emerging issues. In some embodiments, the framework can establish zones of operations, similar to network vitals (e.g., runtime, current and/or past characteristics, performance, attributes, and the like); therefore enabling the framework to recognize and leverage KPI movements respective to certain regions and/or boundaries in order to address detected and/or predicted anomalies. Accordingly, in some embodiments, such adaptations can leverage global learnings (e.g., across networks and/or locations) while maintaining a highly personalized, individualized and/or independent adaptation for each network Such proactive monitoring capability can enable early intervention before problems become severe enough to significantly impact user experience, potentially preventing service interruptions entirely through preemptive adjustments and optimizations.

In some embodiments, the framework can provide a seamless handoff between self-service and assisted support channels. In some embodiments, the framework can maintain contextual awareness when users transition from direct interaction with the consumer-facing application to engagement with call center representatives, ensuring that diagnostic information and troubleshooting progress are preserved. Such continuity can eliminate the frustration of repeating information and restarting diagnostic processes, creating a more integrated and efficient support experience regardless of which interaction channel users ultimately select.

Accordingly, as discussed herein, the present disclosure provides a computerized framework for real-time network troubleshooting powered by AI. The framework can provide an intelligent system capable of diagnosing and resolving network issues through multiple engagement channels. In some embodiments, the framework can implement a multi-agent architecture that enables interaction with users via a conversational interface, delivering personalized guidance and automated network interventions.

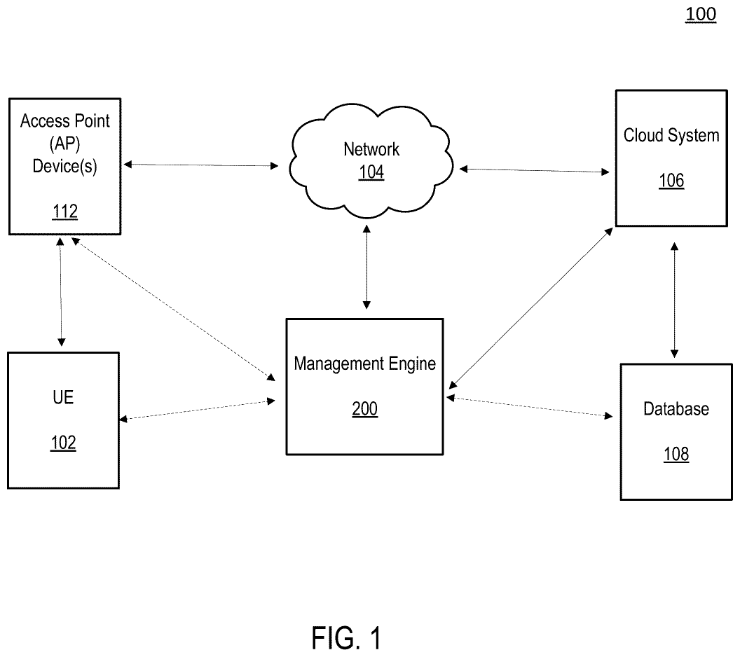

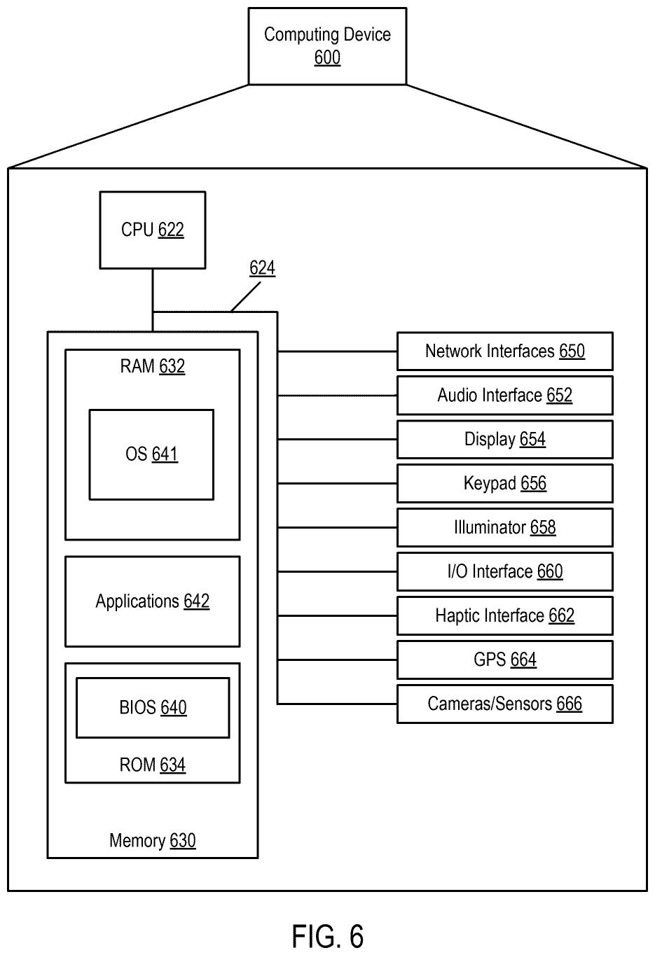

With reference to FIG. 1, system 100 is depicted which includes user equipment (UE) 102 (e.g., a client device, as mentioned above and discussed below in relation to FIG. 6), AP device 112, network 104, cloud system 106, database 108 and execution engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver. In some embodiments, UE 102 can be an access point.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, UE 102 can correspond to, but not be limited to, any type of device, component and/or sensor associated with a location of system 100 (referred to, collectively, as “sensors”). In some embodiments, the UE 102 can be any type of device that is capable of sensing and capturing data/metadata related to activity of the location. For example, the UE 102 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. In some embodiments, UE 102 can be associated with any device connected and/or operating on cloud system 106 (e.g., a cloud-based device, such as a server that collects information related to the location, for example).

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®, for example) and/or internet service provider, and the like, which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or execution engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

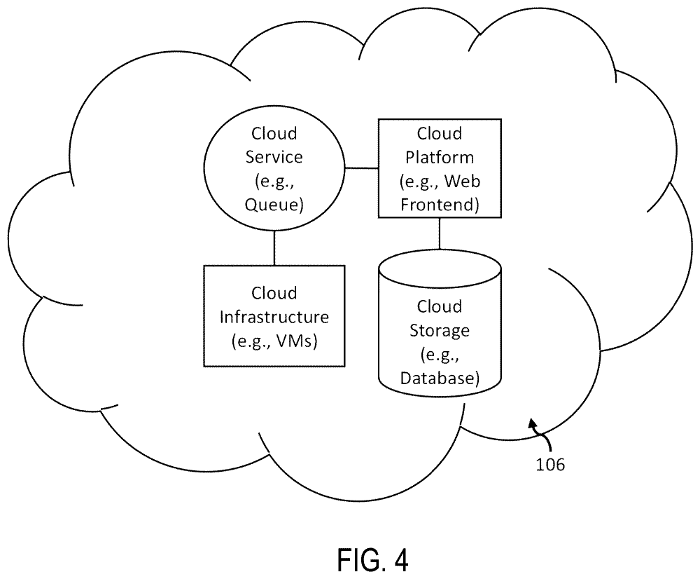

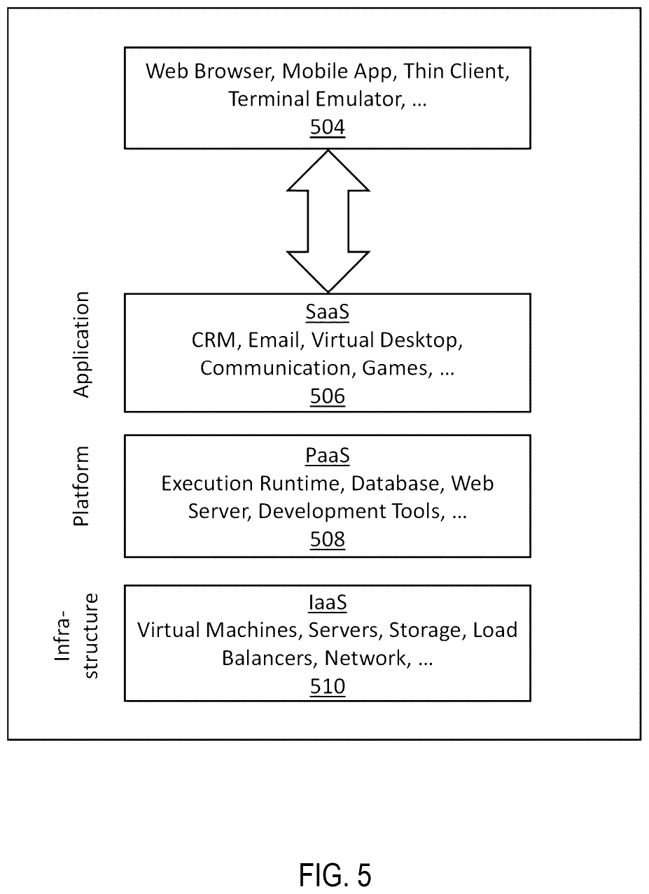

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Execution engine 200, as discussed above and further below in more detail, can include components for the disclosed functionality. According to some embodiments, execution engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, execution engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, execution engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102. In some embodiments, such application may be a web-based application accessed by AP device 112 and/or UE 102, and/or devices accessible over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102. Accordingly, as provided below, engine 200 can execute on a device, at a network location, on nodes of a network and/or across a network, on differing components to perform the operations of each module executing therein.

Accordingly, as discussed herein, the disclosed functionality can be configured as an application, service, product, API, software library, plugin, software development kit (SDK), and the like. Indeed, such functionality, as represented by engine 200, can function as a stand-alone application (e.g., application executing on a user device and/or server, for example), as middleware, at the edge, and/or at any other location on a network, as discussed above and depicted in FIG. 1

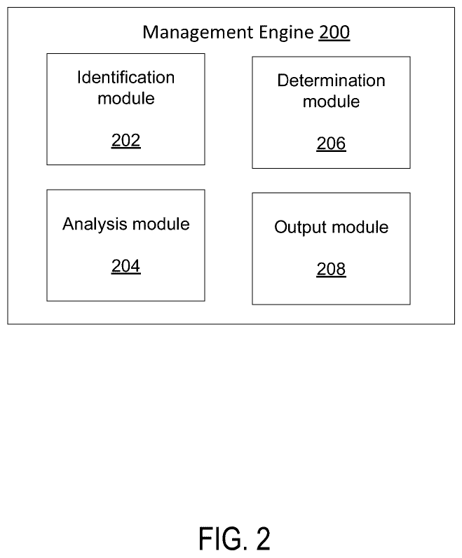

As illustrated in FIG. 2, according to some embodiments, execution engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

According to some embodiments, engine 200 or other device(s) running Process 300 may be operated entirely at the user device level, or with cloud support as a distributed system, or at a service provider's infrastructure, as non-limiting implementation examples. It will be understood that the disclosure herein provides for a configuration that is platform agnostic and may be operated on multiple alternative platforms as a matter of design choice using the teachings described.

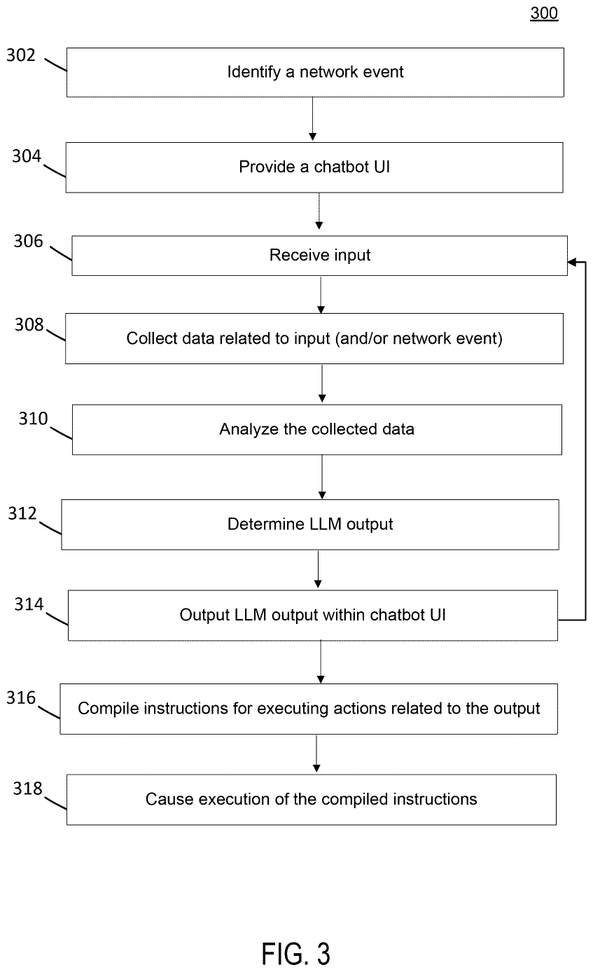

Turning to FIG. 3, Process 300 provides non-limiting example embodiments for the disclosed network management and/or troubleshooting framework. Accordingly, as discussed herein, the present disclosure provides a computerized framework for real-time network troubleshooting powered by AI. The framework can provide an intelligent system capable of diagnosing and resolving network issues through multiple engagement channels. In some embodiments, the framework can implement a multi-agent architecture that enables interaction with users via a conversational interface, delivering personalized guidance and automated network interventions. In some embodiments, the multi-agent architecture enables interaction with external systems, which can include, application servers, application server status aggregators (e.g., Downdetector), Retrieval Augmented Generation (RAG), and the like.

In some embodiments, the framework can operate in modes including: as a self-service application accessible directly to subscribers, as a web-based companion tool for customer support representatives, and as a system-level integration that augments existing operational infrastructure. The framework can employ advanced language model technologies to perceive network conditions, apply complex reasoning to identify root causes, and develop and/or execute action plans for issue resolution. In some embodiments, the framework can assimilate data from both consumer-side and provider-side network elements to create a comprehensive view of network status.

As discussed herein, the framework can utilize techniques including Chain-of-Thought, Tree-of-Thought, Reasoning and Acting (ReAct), Retrieval Augmented Generation, tool manipulation capabilities, and human feedback mechanisms to enable autonomous troubleshooting while continuously improving performance through experiential learning. The framework can execute automated network adjustments when appropriate or guide users through manual interventions when physical action is required. Such modular approach can enable communications and service providers to enhance customer satisfaction through improved first-call resolution rates while simultaneously reducing support costs and increasing network reliability.

According to some embodiments, Steps 302, 306 and 308 of Process 300 can be performed by identification module 202 of execution engine 200; Steps 304 and 314-318 can be performed by output module 208; Step 310 can be performed by analysis module 204; and Step 312 can be performed by determination module 206.

According to some embodiments, Process 300 begins with Step 302 where engine 200 can identify a network event requiring attention through one of multiple detection mechanisms. Such identification can occur via user-initiated triggers such as explicit support requests submitted through client applications, WebSocket-based alert messages transmitted to call center APIs, or natural language queries processed through voice-to-text conversion modules. Alternatively, engine 200 can detect network events autonomously through continuous monitoring of network telemetry data, including Simple Network Management Protocol (SNMP) traps, syslog messages, Internet Control Message Protocol (ICMP) packet loss rates, Transmission Control Protocol (TCP) retransmission counters, Quality of Service (QoS) metrics falling outside of established thresholds, and the like, or some combination thereof.

In some embodiments, engine 200 can employ time-series analysis on network throughput measurements, examining patterns in jitter, latency, and packet delivery ratios against dynamic baseline profiles established for particular network segments. Local-level detection can leverage on-premises agents installed on customer premises equipment (CPE) that monitor radio frequency (RF) interference patterns, channel utilization percentages, or client association failures, while server-side detection can aggregate NetFlow data, Internet Protocol Flow Information Export (IPFIX) records, Border Gateway Protocol (BGP) routing stability indicators across multiple service regions, and the like.

In some embodiments, Step 302 can involve the identification of information, which can include, but is not limited to, a type of device, identity (ID) of device, MAC address or IP address of a device, user account associated the device, and the like, or some combination thereof.

In Step 304, engine 200 can provide a chatbot user interface (UI) that can be dynamically constructed based on the detected event context. For local implementations, engine 200 can generate a WebSocket-connected React component that integrates into existing mobile or desktop applications, featuring context-aware conversation flows with pre-populated diagnostic questions. For call center implementations, engine 200 can render an HTML5/CSS3 web application with enhanced visualization capabilities, including network topology maps, real-time performance graphs, and interactive troubleshooting decision trees.

In some embodiments, the interface can implement responsive design patterns that adapt to device characteristics while maintaining accessibility standards. Authentication mechanisms can be established through OAuth 2.0 protocols or security assertion markup language (SAML)-based single sign-on integrations depending on the implementation environment, with appropriate role-based access controls applied to regulate feature availability between end-users and technical support personnel.

In Step 306, engine 200 can receive and process chatbot inputs. In some embodiments, engine 200 can parse natural language text inputs through transformer-based language models, extracting entity relationships, intent classifications, and sentiment indicators with confidence scores. Voice inputs can be processed through automatic speech recognition pipelines with domain-specific language models optimized for networking terminology, achieving word error rates below k (e.g., 5% for example) in acoustically challenging environments. Engine 200 can maintain contextual awareness across conversational turns through attention-based mechanisms that reference previous exchanges stored in conversation state objects, enabling coherent multi-turn interactions. Input preprocessing can include spelling correction, technical term normalization, and acronym expansion to standardize inputs before semantic analysis.

In Step 308, engine 200 can collect and assimilate comprehensive network data related to the network event and/or input (from Step 306). Engine 200 can deploy ephemeral collection agents programmatically instantiated across relevant network segments, gathering structured and unstructured data from heterogeneous sources. Collected data can include layer 2 frame error statistics, wireless spectrum analysis data in 2.4 GHz and 5 GHz bands, IPv4/IPv6 routing table states, DNS resolution latencies, transport layer security (TLS) handshake completion times, and application-layer response codes. Engine 200 can query RADIUS authentication logs, dynamic host configuration protocol (DHCP) lease databases, MAC address tables to establish device identity and connection history, and the like. In some embodiments, engine 200 can correlate current observations with historical patterns stored in time-series databases, applying locality-sensitive hashing algorithms to identify similar past incidents based on multidimensional feature vectors extracted from previous troubleshooting sessions. Data normalization procedures can standardize metrics across different vendor implementations, enabling unified analysis despite heterogeneous network components.

In some embodiments, such collection can be performed periodically according to a criteria (e.g., time, date, interval, request, and the like, or some combination thereof), continuously, and/or according to the detection of an event (e.g., detecting a device connecting to the network, detecting a device disconnecting to the network, detecting a device being added/removed from the network, and the like), as per Step 302, discussed supra.

In some embodiments, such collected information can be based on, but not limited to, a device ID, device type and/or designation (e.g., primary routers, repeaters, endpoints, and the like), device capabilities, connectivity data (e.g., signal strength, signal quality, throughput, latency, bandwidth, and the like), connectivity type (e.g., which type of radio—for example, 2.4 GHz, 5 GHz and/or 6 GHz, for example; supported WiFi Standards (e.g., 802.11n, 802.11ac, 802.11ac); WiFi generations (e.g., WiFi 5/6/7, and the like) number of antennas (MIMO capabilities), and the like. Thus, a comprehensive set of device information can be collected for which an understanding of a required and/or current network configuration can be determined, as discussed herein.

In Step 310, engine 200 can analyze the LLM input through a multi-stage processing pipeline incorporating symbolic and statistical reasoning techniques. Initial parsing can segment inputs into semantic units, applying domain-specific entity recognition to identify technical parameters, device references, and reported symptoms. The analysis can leverage knowledge graph traversal algorithms to establish relationships between reported issues and potential causes, with edge weights derived from historical correlation strengths. Transformer-based encoders/decoders can process natural language descriptions into dense vector representations (e.g., word embeddings) for similarity matching against known issue patterns. Engine 200 can employ Bayesian inference networks to calculate conditional probabilities for various failure hypotheses given the observed symptoms and network conditions. Advanced techniques including temporal causal modeling can identify leading indicators that preceded the reported issue, helping distinguish between root causes and downstream effects of the network event.

Accordingly, in some embodiments, engine 200 can perform the analysis in Step 310 by calling and executing an AI and/or ML model and/or a LLM. Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

In Step 312, engine 200 can determine LLM output that determines troubleshooting strategies tailored to the identified root cause. In some embodiments, for example, engine 200 can utilize, but is not limited to, Monte Carlo Tree Search algorithms to explore potential solution paths, evaluating their expected efficacy through simulation against network models derived from the collected data. It should be understood that any of the AI/ML mechanisms discussed above can be utilized to determine the optimal and/or appropriate solution for the network event.

In some embodiments, engine 200 can generate candidate solutions as structured action sequences, with each action annotated with preconditions, expected outcomes, failure modes, and contingency procedures. Solution paths can be ranked using multi-objective optimization that balances resolution probability, implementation complexity, potential for service disruption, and alignment with service provider policies. The generated outputs can include YAML-formatted configuration changes, command line interface (CLI) command sequences, Python or Bash scripts for automated execution, or human-readable instructions with appropriate technical depth based on the intended recipient's expertise level. Each recommendation can be accompanied by explanatory rationales that cite specific evidence from the collected data supporting the proposed course of action.

In Step 314, engine 200 can output the LLM-generated response through adaptive rendering pipelines that format content appropriately for the target interface (within the UI from Step 302, discussed supra). For end-user interfaces, engine 200 can generate conversational outputs with controlled technical vocabulary, employing analogies and simplified explanations where appropriate, while maintaining accuracy. Visual components can include SVG-based network topology visualizations with color-coded status indicators, bandwidth utilization heat maps, or step-by-step animated illustrations of physical actions required. For technical interfaces, engine 200 can include JavaScript Object Notation (JSON)-structured diagnostic data, request for comments (RFC)-compliant protocol analysis, packet capture excerpts, or log correlation timelines. The output can employ progressive disclosure patterns that allow users to expand technical details as needed without overwhelming initial presentations. Real-time translation services can be applied when necessary to present information in the user's preferred language while preserving technical accuracy.

In Step 316, engine 200 can compile executable instructions through a cross-platform action planning subsystem. For network device configuration changes, engine 200 can generate vendor-specific command sets (e.g., Cisco IOS, Juniper JUNOS, or OpenWrt syntax) appropriate for the target infrastructure. For cloud-based service modifications, engine 200 can produce representational state transfer (REST) API calls with proper authentication headers, request bodies, and idempotency tokens. For customer premise equipment (CPE) adjustments, engine 200 can create TR-069 parameter objects or NETCONF/YANG-compliant configuration changes. Such compilation process can include dependency resolution to ensure prerequisites are satisfied before critical changes, transaction boundaries to enable atomic execution or rollback capabilities, and validation rules to verify syntax and semantic correctness prior to execution. In some embodiments, security checks can scan generated instructions for potentially harmful operations, applying appropriate authorization guards based on user roles and execution contexts.

In Step 318, engine 200 can cause execution of the compiled instructions through a multi-modal execution framework that selects appropriate channels based on the nature of the required actions. For network configuration changes, engine 200 can establish secure shell (SSH) or TLS-protected API connections to network elements, executing commands with proper privilege escalation and session logging. For user-guided actions, engine 200 can present sequenced instructions with confirmation checkpoints, capturing progress indicators through interactive feedback mechanisms. The execution process can implement circuit-breaker patterns that monitor for unexpected responses, automatically halting potentially destructive sequences if predefined safety thresholds are exceeded. Accordingly, the execution can involve adjustment of network parameters, characteristics, features and/or capabilities, which can enable network service to be adjusted/modified back to threshold service levels.

In some embodiments, upon completion of each action, engine 200 can perform verification procedures that collect telemetry data validating the expected state changes, calculating confidence scores for issue resolution. In some embodiments, engine 200 can employ exponential backoff strategies for retrying failed operations where appropriate, while maintaining comprehensive audit logs of all executed actions for regulatory compliance and operational review purposes.

By way of a non-limiting example, according to some embodiments, in line with the steps of Process 300 discussed above, a user at home begins experiencing significant slowdowns while streaming media on a smart TV during peak evening hours. The household network, managed via a mesh Wi-Fi system, supports several connected devices including smartphones, laptops, IoT appliances, and gaming consoles. The user opens a locally installed network assistant application embedded with an LLM-driven chatbot interface. In some embodiments, such application can be directly integrated with the home router and access points through secure local APIs, allowing it to issue diagnostic queries and execute configuration changes. In some embodiments, such application can receive information from other systems, applications, APIs, devices, and the like, which can provide information related to network-wide incidents, which may be related to network events, power events, application server outages, account issues, and the like, or some combination thereof.

Upon launch, the LLM-powered framework initiates a real-time diagnostic analysis of the network. It accesses local telemetry and performance logs, measuring signal strength, bandwidth utilization, device load, and recent error events. The analysis reveals that the smart TV is connected to a congested 2.4 GHz band with high interference and overlapping channels. Simultaneously, multiple devices in the household are engaged in high-bandwidth background tasks, including cloud backups and software updates, which are consuming the majority of the available throughput.

The LLM interprets the collected data and correlates it with known network fault patterns. It identifies several contributing issues: suboptimal band allocation, absence of traffic prioritization rules, and excessive simultaneous usage of shared bandwidth. Without requiring further user input, and based on default permissions configured during initial setup, the framework proceeds to automatically execute a sequence of corrective actions designed to optimize network performance.

First, the framework initiates band steering to transition the smart TV from the 2.4 GHz band to the less congested 5 GHz band, which provides higher throughput and lower latency. Next, the framework enables a dynamic QoS policy that prioritizes streaming traffic from the smart TV's MAC address over other types of traffic. Concurrently, the agent temporarily throttles non-critical bandwidth-heavy operations across lower-priority devices, such as cloud sync operations on two laptops and a smart home hub's firmware update. To improve future stability, the framework scans for the least crowded Wi-Fi channels and reassigns the access point handling the smart TV to operate on an optimized channel, minimizing external interference from neighboring networks.

Each of these actions can be executed through a series of validated API calls to the network hardware, with internal checks confirming success and measuring performance improvements after changes are applied. Within minutes, the network is rebalanced, and the smart TV resumes stable, high-resolution streaming. Post-resolution, the system logs the actions taken, updates a local incident history, and flags the event for future optimization learning.

This local, autonomous execution flow illustrates how a user-facing LLM interface, tightly integrated with real-time telemetry and device control systems, can independently resolve network faults without human intervention, improving user experience and reducing dependency on external technical support.

By way of another example, according to some embodiments, a customer contacts their internet service provider's support line after experiencing frequent video call dropouts and voice lag during remote work meetings. The issue has persisted intermittently for several days. The customer service representative (CSR), working in a centralized support center, receives the call and authenticates the user's account through a secure dashboard. The dashboard is integrated with a server-side instance of the network troubleshooting framework, which is capable of remote diagnostics and control of the customer's network environment.

Upon accessing the customer's network profile, the representative uses the framework's LLM-powered interface to begin a diagnostic inquiry. The LLM receives a natural language prompt containing a summary of the customer's complaint. In response, the framework retrieves real-time telemetry from the customer's home gateway, including data on signal quality, device connectivity, usage patterns, error rates, bandwidth utilization, and historical incident logs. The framework correlates these data points with known fault patterns and automatically generates a root cause analysis.

The analysis identifies several performance degradations: the customer's VoIP devices are connected to an access point located on a different floor than the user, resulting in a weak signal and occasional packet loss. Additionally, multiple high-bandwidth devices—including a gaming console and a cloud-connected security system—are active during business hours and consuming significant uplink capacity, introducing jitter into the voice stream. The customer's current configuration does not include QoS prioritization or load balancing between access points.

With this diagnosis, the LLM framework recommends a series of remedial actions, which the CSR reviews and approves. These actions are then automatically executed via secure API calls from the server to the customer's local gateway and mesh network. The framework first enables QoS rules prioritizing voice traffic based on destination ports and protocol patterns. The framework can then instructs the nearest access point to increase signal strength thresholds to promote a better roaming decision for the VoIP devices. The framework also schedules non-critical background updates and data transfers from other devices to execute outside the customer's working hours.

To ensure long-term resolution, the framework scans the wireless environment for interference and selects optimized channels for both the 2.4 GHz and 5 GHz bands. It applies these changes without requiring a network reboot, minimizing service disruption. Once complete, the framework monitors network performance metrics for several minutes to confirm stability improvements and reduced packet loss on prioritized streams.

The representative informs the customer that corrective actions have been taken remotely, and the framework confirms measurable improvements in voice traffic performance. All changes are logged automatically, and a follow-up test is scheduled for the next workday to verify persistent performance. This remote troubleshooting session demonstrates the ability of the framework to translate conversational inputs into precise technical actions—executed over the network—without requiring the customer to make any manual adjustments.

In yet another non-limiting example, according to some embodiments, a business customer, Maria, is experiencing intermittent VoIP call drops during video conferences. After attempting to troubleshoot the issue on her own, she contacts the support center via a messaging app on her phone. A call center representative, equipped with the framework's server-side interface, responds promptly and begins the diagnostic process.

The representative, using a secure remote connection, accesses Maria's network telemetry through the centralized cloud framework. The framework automatically retrieves real-time data from Maria's network devices, including the router, switches, and access points, as well as the logs from the VoIP service running on her desktop. After a quick analysis, the framework reveals a pattern of jitter and packet loss during peak usage hours, with occasional network congestion caused by multiple devices simultaneously streaming video and transferring large files.

The framework's LLM, trained to understand network behavior and faults, identifies several possible causes for the instability. It flags a particularly high jitter value when Maria's network is under load, particularly during heavy traffic bursts from non-prioritized devices like file servers and video streaming services. The LLM recommends a set of actions that could mitigate the jitter and reduce the packet loss, specifically suggesting a bandwidth management policy to prioritize VoIP traffic over other types of data.

Maria grants the representative remote access to perform the suggested actions (e.g., and/or may have previously opted into continuous enablement rather than being an authorization for each instance) The representative, using the same framework, triggers the QoS feature through the framework's dashboard. The framework automatically configures the router to prioritize VoIP and video conferencing traffic, ensuring that packets related to Maria's calls are handled with higher precedence over less time-sensitive traffic. Furthermore, the framework reduces the available bandwidth for background tasks such as cloud backups and streaming media on other devices during work hours, preventing these activities from overwhelming the network.

To further stabilize the connection, the framework also analyzes the wireless signal distribution across Maria's office space. It discovers that her VoIP phone is connected to an access point located too far from her desk, resulting in weaker signal strength and inconsistent performance. The framework automatically shifts the device to a nearby access point with a stronger signal and reconfigures the access point's channel settings to avoid interference from neighboring networks.

Once all actions are executed, the framework tests the network stability by simulating a VoIP call under high load. The framework confirms that the jitter is significantly reduced, and the packet loss rate is now within acceptable limits. The CSR shares this information with Maria, confirming that the issue has been resolved and advising her to monitor the network over the next few days to ensure continued stability.

The framework logs all actions taken, including the adjustments to bandwidth prioritization, device reassignment, and signal optimizations. Such logging, as discussed above, can be recorded (e.g., in database 108) so that it can be later referenced in the event of any future, related service needed. Maria is notified of the changes, and a detailed report is sent to her email. The entire process, from diagnosis to resolution, is completed, for example, within a few minutes, demonstrating the power of the framework to autonomously resolve network issues remotely, with minimal intervention from the support agent. Accordingly, the framework can provide functionality for interpreting a multi-dimensional space of network signals into meaningful insights to establish, as discussed above, root-cause determinations and structured, actionable plans to effectively and rapidly address network and/or device issues.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying, by an application, a network event, the network event associated with a device connected to a network at a location, the network event corresponding to a change of network service associated with the network that alters a user experience with the network;
providing, by the application, a user interface (UI), the UI comprising functionality for addressing the network event, the UI corresponding to chatbot functionality provided by the application;
executing, by the application, an artificial intelligence (AI) model based on input provided respective to the UI, the input comprising at least one interaction with the chatbot functionality, the at least one interaction comprising information indicating at least one request for assistance with functionality of the network from a device perspective and an executable action for altering the functionality to address the network event; and
causing, by the application, execution of the executable action, the execution causing adjustment of network characteristics such that the change of the network service is addressed.

2. The method of claim 1, further comprising the adjustment comprising modifying network parameters to threshold levels of the network service.

3. The method of claim 1, further comprising controlling at least one device on the network to perform the adjustment of the network characteristics, the at least one device comprising an access point.

4. The method of claim 1, further comprising the executable action comprising a data structure, that when executed, causes the adjustment of network characteristics.

5. The method of claim 1, further comprising:
compiling, by the application, a set of instructions, wherein the executable action is the set of instructions; and
communicating, via the UI, the set of instructions for execution via the device.

6. The method of claim 1, further comprising:
obtaining network data from at least one other network; and
analyzing the input based at least on the obtained network data.

7. The method of claim 1, further comprising:
monitoring, by the application, network activity of the device on the Wi-Fi network;
collecting, by the application, data related to the network event;
analyzing, by the application, the data; and
determining, by the application, the network event, wherein the identification of the request is based on the determination of the network event.

8. The method of claim 1, further comprising the network being a Wi-Fi network, the change corresponding to an event occurring in the location, outside the location, or a combination thereof.

9. A system comprising:
a processor configured to:
identify, by an application, a network event, the network event associated with a device connected to a network at a location, the network event corresponding to a change of network service associated with the network that adjusts a user experience with the network;
provide, by the application, a user interface (UI), the UI comprising functionality for addressing the network event, the UI corresponding to chatbot functionality provided by the application;
execute, by the application, an artificial intelligence (AI) model (LLM) based on input provided respective to the UI, the input comprising at least one interaction with the chatbot functionality, the at least one interaction comprising information indicating at least one request for assistance with functionality of the network from a device perspective and an executable action for altering the functionality to address the network event; and
cause, by the application, execution of the executable action, the execution causing adjustment of network characteristics such that the change of the network service is addressed.

10. The system of claim 9, wherein the processor is further configured such that the adjustment comprises modifying network parameters to threshold levels of the network service.

11. The system of claim 9, wherein the processor is further configured to control at least one device on the network to perform the adjustment of the network characteristics, the at least one device comprising an access point.

12. The system of claim 9, wherein the processor is further configured such that the executable action comprises a data structure, that when executed, causes the adjustment of network characteristics.

13. The system of claim 9, wherein the processor is further configured to:
compile, by the application, a set of instructions, wherein the executable action is the set of instructions; and
communicate, via the UI, the set of instructions for execution via the device.

14. The system of claim 9, wherein the processor is further configured to:
obtain network data from at least one other network; and
analyze the input based at least on the obtained network data.

15. The system of claim 9, wherein the processor is further configured to:
monitor, by the application, network activity of the device on the Wi-Fi network;
collect, by the application, data related to the network event;
analyze, by the application, the data; and
determine, by the application, the network event, wherein the identification of the request is based on the determination of the network event.

16. A method comprising:
identifying, by an application, a network event, the network event associated with a device connected to a network, the network event corresponding to a change of network service associated with the network;
collecting, by the application, data related to the network event;
analyzing, by the application, via execution of an artificial intelligence (AI) model, the collected data, the analysis comprising the application addressing a cause of the change of network service;
determining, based on the AI model analysis, an executable action for altering functionality of the network to address the network event; and
causing, by the application, execution of the executable action, the execution causing adjustment of network characteristics such that the change of the network service is addressed.

17. The method of claim 16, further comprising communicating, over a network, instructions to the device, the communication causing the execution of the adjustment of the network characteristics.

18. The method of claim 16, further comprising:
compiling an electronic report based on the executable action, the electronic report comprising information related the network event and steps taken to perform the adjustment of network characteristics; and
communicating, over the network, the electronic report, the communication causing storage of the information in a log.

19. The method of claim 18, further comprising training the AI model based on the electronic report, such that the training enables the AI model to predict future occurrences of the network event.

20. The method of claim 16, further comprising:
determining a context of the network event based at least in part on information related to the device; and
customizing the executable action based on the context.
